(19) United States
(12) Patent Application Publication
(10) Pub. No.: US 2010/0225810 A1
(43) Pub. Date: Sep. 9, 2010

(54) METHOD FOR SYNCHRONIZING A CONTENT STREAM AND A SCRIPT FOR OUTPUTTING ONE OR MORE SENSORY EFFECTS IN A MULTIMEDIA SYSTEM

(75) Inventors: Winfried Antonius Henricus Berkvens, Eindhoven (NL); Roel P.G. Cuppen, Eindhoven (NL); Ramon A.W. Clout, Eindhoven (NL); Richard S. Cole, Redhill (GB); David A. Eves, Crawley (GB); Mark H. Verberkt, Eindhoven (NL)

Correspondence Address: BURNS & LEVINSON, LLP, 125 SUMMER STREET, BOSTON, MA, 02110, US

(73) Assignee: AMBX UK LIMITED, Redhill, Surrey (GB)

(21) Appl. No.: 12/602,696

(22) PCT Filed: Jun. 30, 2008
(86) PCT No.: PCT/IB2008/052625

§ 371 Date: May 18, 2010

(30) Foreign Application Priority Data
Jul. 6, 2007 (EP) 07111952.3

(51) Int. Cl. H04N 5/04; G06K 9/00

(52) U.S. Cl. 348/500; 382/100; 348/E05.009

(57) ABSTRACT

A method for synchronizing a content stream (10) and a script (70) comprises the acts of calculating (80) a fingerprint (30) comprising a number of bits, from a portion (20) of the content stream; determining (50) a time value (40) corresponding to the calculated fingerprint (30); synchronizing a portion of the script (90) that corresponds to the time value (40) and the portion (20) of the content stream (10). The method is characterized in comprising a step in which the number of bits is determined in dependence of at least one of the fingerprints chosen from a group comprising the calculated fingerprint (30), an expected fingerprint (130) corresponding to said calculated fingerprint, another calculated fingerprint (110) calculated from another portion (100) of said content stream, and another expected fingerprint (120) corresponding to said another calculated fingerprint (110). The script (70) represents one or more sensory effects to be output in an effects signal to an effects controller.

### FIELD OF THE INVENTION

The invention relates to a method for synchronizing a content stream and a script for outputting one or more sensory effects in a multimedia system according to the preamble of claim 1. The invention further relates to a receiver for synchronizing a received content stream and a script for outputting one or more sensory effects in a multimedia system according to the preamble of claim 19.

### BACKGROUND OF THE INVENTION

With the explosion of the number of home entertainment systems based upon the accelerating evolution of computer technology, there is a desire to create greater user involvement in the actual outputs by developing effects that impact a user's sensory perception including changing lights, vibrations, temperatures, winds, sounds, smells, for example. This desire has evolved from the large scale rides that many theme parks are using to attract visitors and the possibilities of developing such dramatic effects in the home, such as related to large screen TVs, high definition TVs, audio experiences, and video games.

International Publications by WIPO, WO 02/092183 to Koninklijke Philips Electronics entitled, “A Real-World Representation System and Language,” and WO 03/100548 to Eves et al., entitled, “Dynamic Markup Language,” disclose means for driving and operating devices according to a description in a markup language to render real-world experiences to the user thereby creating a greater user involvement.

WO application IB2006/054809 “Script Synchronization using fingerprints determined from a content stream”, attorney docket PH002256, discloses a method for synchronizing a content stream and a script for outputting one or more sensory effects. To enable synchronization a fingerprint is calculated from a portion of the content stream and a time value corresponding to the fingerprint is retrieved from a fingerprint database. The portion of the content stream is rendered in synchronization with the script utilizing said time value. The script is utilized to produce one or more sensory effects that are output in an effects signal for an effects controller.

In order to have a reliable synchronization an accurate and unique fingerprint should be calculated from the portion of the content stream. There are however conditions that impact the accuracy of the calculated fingerprint. A fingerprint is accurate when its value matches to a value of an expected fingerprint in the fingerprint database that has been calculated beforehand from the same portion of the content. The content stream may be video material that has been transferred in the analogue domain, e.g. composite video, S-video or RGB video. Noise introduced in the analogue domain on the video material may alter the fingerprint that is calculated from the portion of the content stream after the content stream has been transferred in the analogue domain, thereby reducing the accuracy of the calculated fingerprint as the fingerprint may have altered that much that the corresponding fingerprint in the fingerprint database calculated from the same portion of the content stream before it was transferred through the analogue domain cannot be found. Further, the calculated fingerprint may be accurate, but not unique. A content stream including a plurality of portions comprising a plurality of mono-colored (e.g. dark) or static scenes may provide a plurality of same fingerprints. As these fingerprints are not unique the synchronization of the script with the content will not be reliable.

### SUMMARY OF THE INVENTION

It is an object of the invention to provide a method for synchronizing a content stream and a script wherein said synchronization has an improved reliability.

This object is achieved with the method as defined in claim 1. By making the number of bits of the calculated fingerprint variable instead of fixed it becomes possible to adapt the calculated fingerprint to the actual content in such a way that it uniquely identifies the content stream. An accurate calculated fingerprint of content that has been transferred in the analogue domain may require an increased number of bits. Also for a unique fingerprint of content having a plurality of dark or static scenes an increased number of bits may be required to enable reliable synchronization. With the method according to claim 1 the number of bits of the calculated fingerprint is determined in dependence of the calculated fingerprint itself or on another fingerprint calculated from another portion of the content stream. The number of bits of the calculated fingerprint may also be dependent on the expected fingerprint corresponding to the calculated fingerprint or the another expected fingerprint corresponding to the another calculated fingerprint. Thus with the method as defined in claim 1 the calculated fingerprint may have an increased accuracy or uniqueness providing an increased reliability of the synchronization of the content stream with the script, thereby achieving the object of the invention.

With a further embodiment of the method as claimed in any one of claims 5-8 the number of bits may be obtained from a comparison of the calculated and the corresponding expected fingerprints or from a comparison of the another calculated and the corresponding another expected fingerprint in a simple way that is easy to implement.

With a further embodiment of the method as claimed in claim 9 the number of bits may be obtained by a simple bit count of the expected or the another expected fingerprint. Both the expected and the another expected fingerprint are available from the fingerprint database. This has the advantage that before doing the actual calculation of the fingerprint from the portion of the content it may be known how many bits the calculated fingerprint should have.

An embodiment of the method according to claim 10 has the advantage of providing a fingerprint comprising K sub-fingerprints, wherein the number of bits L comprised in each sub-fingerprint is easily adjustable by adjusting the size and the number of the elements in the matrix. An element may represent a group of pixels in a specific part of the frame. By decreasing the size of the element the associated average luminance may change as individual pixels will have a larger contribution in said average luminance thereby providing potentially more discriminative power to said element. Thus by decreasing the size of the element the number of bits L comprised in the sub-fingerprint is increased providing a more unique fingerprint.

The embodiment of the method according to claim 11 has the advantage that during calculation of a sub-fingerprint an indication of the accuracy of said sub-fingerprint may be obtained and in response thereto the number of bits comprised in the sub-fingerprint may be increased. Each bit in the sub-fingerprint results from a subtraction of two corresponding first elements from two first arrays, the two first arrays being associated with two consecutive frames. When two corresponding first elements have a low value the bit in the sub-fingerprint being dependent on the sign of the result of the subtraction of these first elements may have a larger likelihood to be incorrect. Thus by examining the first elements in the first arrays the indication on the accuracy of the fingerprint may be obtained, and as a result the number of bits in each sub-fingerprint may be changed.

In a further embodiment of the method as defined in claim 13 a quality number for a sub-fingerprint may be determined. Said quality number may relate to the difference in average luminance of two consecutive frames corresponding to the second array for which said quality number is calculated. Said quality number is obtained by a simple summing of the absolute values of the elements of the second array. The number of bits comprised in the sub-fingerprint may be changed in response to said quality number.

A further embodiment of the method as claimed in any one of claims 14-16 has the advantage that the number of bits in the determining step of the method as claimed in claim 1 is determined in dependence of the easily obtainable quality number of the sub-fingerprints comprised in the expected fingerprint, or in the another calculated fingerprint or in the calculated fingerprint.

A further embodiment of the method as claimed in claim 18 has the advantage that the reliability of the synchronization of the script to the content after a jump, such as e.g. fast forward, is further improved. After a jump the calculation of the fingerprint may still use the same number of bits as the calculation of the fingerprint just before the jump. However the corresponding expected fingerprint related to the content after the jump may require a different number of bits. To facilitate the synchronization after a jump two or more corresponding expected fingerprints having a different number of bits may be comprised in the timetable or fingerprint database.

With an embodiment of the receiver as claimed in claim 19 the received content stream and script for outputting one or more sensory effects in a multimedia system may be synchronized. Said receiver may be used to drive and operate an effects controller according to the script, the script comprising a description in a markup language. Thus with the receiver and the effects controller real-world experiences may be rendered, thereby creating a greater user involvement.

It should be expressly understood that the drawings are included for illustrative purposes and do not represent the scope of the present system. In the accompanying drawings, like reference numbers in different drawings designate similar elements.

### BRIEF DESCRIPTION OF THE DRAWINGS

In the drawings:

FIG. 1 illustrates the method for synchronizing the content stream with the corresponding script stream by means of fingerprints; and

FIG. 2 illustrates a method for calculating a fingerprint comprising a plurality of sub-fingerprints.

FIG. 3 shows an embodiment of a receiver for synchronizing a received content stream and a script.

### DETAILED DESCRIPTION OF THE EMBODIMENTS

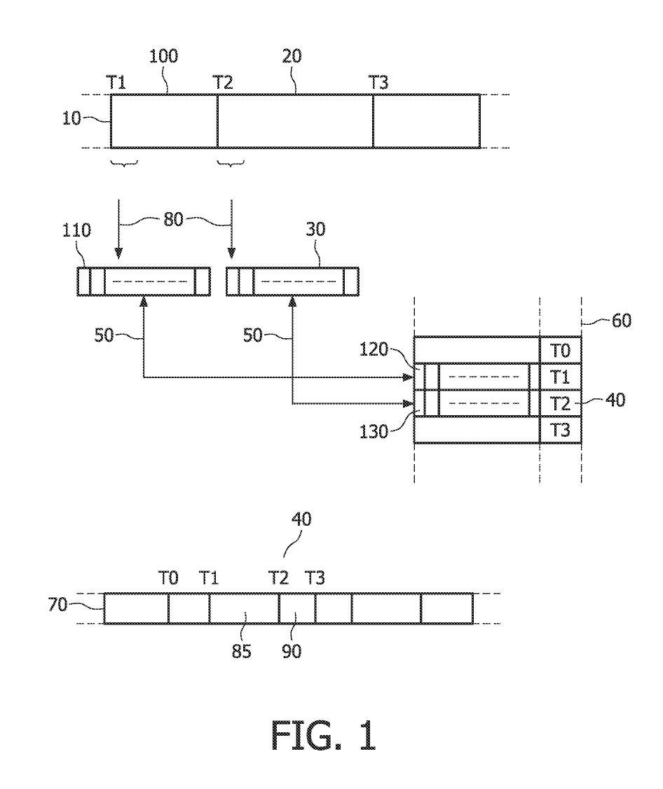

The present method and receiver for synchronizing a received content stream and a script is illustrated in the FIGS. 1, 2 and 3 and described herein. Referring to FIG. 1, a content stream 10 (provided by a broadcaster, by a DVD producer/player, etc.) comprises a plurality of portions 20, 100. From a portion 20 of the content stream 10 a fingerprint 30 is determined or calculated 80. In this way, each fingerprint corresponds to a particular start time (e.g., times T0, T1, T2, T3, . . . TN) of portions of the content stream.

The fingerprint is determined or calculated 80 from the content stream 10 by operating upon the information comprised in the content stream. The fingerprint may be determined in any manner, including performing a hashing function on the selected portions of the content stream data to arrive at a hashed value.

As shown, the content stream 10 is broken into content portions 20, 100. The content portions 20, 100 correspond to script portions 85, 90 that are intended to be executed in synchronization with the content portions 20, 100. In other words, as the portion 20 of content stream 10 is rendered that corresponds to a start time T2, the script portion 90 corresponding to that content portion start time is started and executed in synchronization. The same is performed for each of the portions of the content stream 10 and the script 70.

To facilitate operation in accordance with the present method, a fingerprint database or timetable 60 is created in advance of the above described synchronized rendering of the content stream 10 and script 70. The fingerprint database or timetable 60 may contain a plurality of fingerprint and time value pairs 130, 40. The fingerprint and time value pairs stored in the fingerprint database 60 are determined or calculated from the content stream in the same way (e.g., utilizing the same algorithm) and in the same portions as during execution of the method or operation of the receiver. The time value 40 provides a relative time for the content portion 20 that the fingerprint 30 was derived from in relation to a beginning of the content stream 10. For example, for a fingerprint 30 derived from a portion 20 of a content stream 10 that would be begin to be serially rendered (e.g., played) at a time T2 40 from the beginning of the content stream 10, the time value would be T2. This time value 40 then may be utilized by the present method or receiver to identify a starting time of a portion of a script 90 that corresponds to this time 40 in the content stream 10 as discussed further below. The timetable or fingerprint database 60 may receive the plurality of fingerprint and time value pairs 130, 40 from any source including a script server, a source of the content stream, etc. The fingerprint and time value pairs 130, 40 may be determined and provided by the content stream or script provider. Regardless of the source, the fingerprint database 60 stores the received fingerprint and time value pairs 130, 40 typically prior to receiving the content stream 10.

The content stream 10 may be distributed by a distribution/transmission channel including over a broadcast channel, the Internet, via optical media, such as digital versatile disks (DVDs), etc. The script 70, and the fingerprint and time value pairs 130, 40 may be provided by the script server that, in one embodiment, distributes the script 70 and the fingerprint and time value pairs 130, 40 over the same distribution system as the content stream 10, such as over the Internet. The script 70 and the fingerprint and time value pairs 130, 40 may be distributed together with the content stream 10, or may be distributed separate from the content stream and be provided by another source that, for example, provides designed scripts for said content stream.

Thus, as explained above, a method for synchronizing a content stream 10 and a script 70 for outputting one or more sensory effects in a multimedia system comprises the acts of:

calculating 80 a fingerprint 30 comprising an integer number of bits from a portion 20 of the content stream;

determining 50 a time value 40 corresponding to the calculated fingerprint 30, by comparing said calculated fingerprint 30 with a plurality of expected fingerprints 120, 130 associated with the content stream 10;

synchronizing a portion 90 of script 70 that corresponds to the time value 40 and the portion 20 of the content stream 10, the script 70 representing one or more sensory effects to be output in an effects signal to an effects controller.

In an illustrative embodiment, the script server may be simply a DVD that comprises the content stream 10, the script 70 and the fingerprint and time value pairs 130, 40. The user may access the DVD with a local DVD player. After receiving the content stream 10, the script 70, and the fingerprint and time value pairs 130, 40, the receiver is enabled to play the content stream 10 in synchronization with the script 70. The local DVD player may have transferred the content stream 10, the script 70, and the fingerprint and time value pairs 130, 40 via an analogue path causing errors in the fingerprints 110, 30 taken from the content stream 10. These errors may disrupt the reliability of the synchronization of the content stream 10 and the script 70.

The invention improves the reliability of the synchronization by using fingerprints 110, 30 and expected fingerprints 120, 130 that are of variable length. Said fingerprints 110, 30 may be made longer or shorter dependent on how difficult it is to synchronize. This enlarges the chance of finding a match between a calculated fingerprint 110, 30 and an expected fingerprint 120, 130 that is comprised in the timetable 60, thereby improving the reliability of the synchronization of the content stream 10 and the script 70.

A processing power required to calculate the fingerprints 110, 30 is dependent on the number of bits comprised in said fingerprints. Having fingerprints with variable length provides an advantage that the number of bits comprised in the fingerprints may only be made longer when necessary (such as for example in dark scenes), thereby reducing an average required processing power. A further advantage is that also the average processing power required for finding a match between the calculated fingerprint 110, 30 and the expected fingerprint 120, 130 is reduced. Yet a further advantage is that a required storage capacity for storing the timetable 60 is reduced.

The method for synchronizing the content stream 10 and the script 70 according to the invention is characterized in that the number of bits comprised in the fingerprints 110, 30 is dependent on at least one fingerprint chosen from the group comprising

the calculated fingerprint 30,

an expected fingerprint 130 corresponding to said calculated fingerprint 30,

another calculated fingerprint 110 calculated from another portion 100 of said content stream 10, and

another expected fingerprint 120 corresponding to said another calculated fingerprint 110.

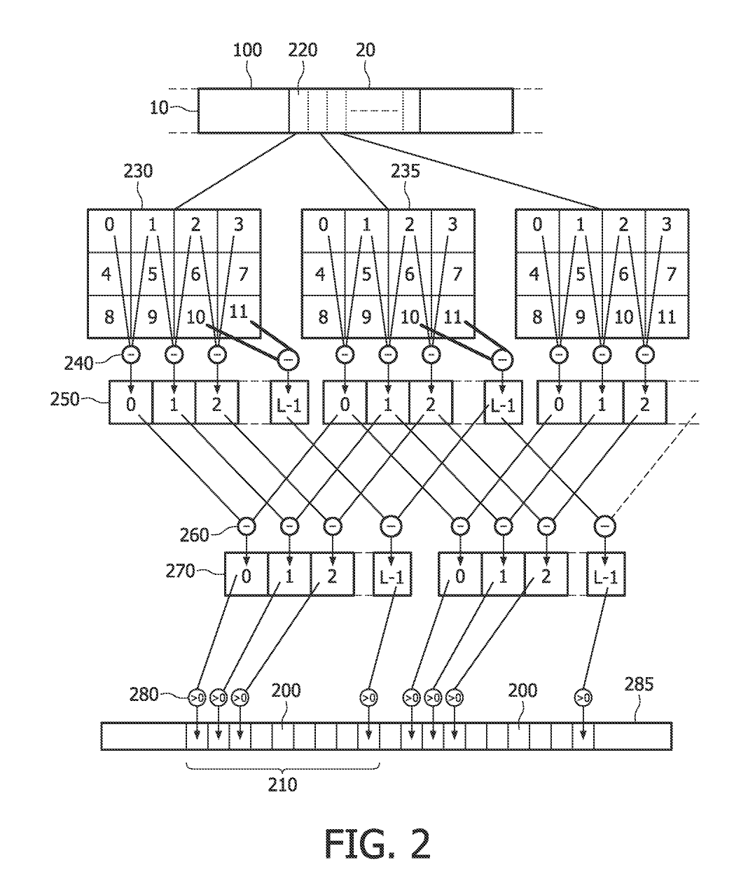

Referring to FIG. 2 each portion 20, 100 of the content stream 10 (e.g. a movie) may comprise a plurality of frames 220. The start of a portion 100, 20 of the content stream 10 may be determined using the calculation of one or more sub-fingerprints 210, each sub-fingerprint being calculated or determined from a predetermined number of frames 220. A fingerprint 30, 100 may then comprise K sub-fingerprints 210, K being an integer larger than 1. In an embodiment of the method for synchronizing the content stream and the script the number of bits comprised in each fingerprint 285 chosen form the group comprising the calculated fingerprint, the expected fingerprint, the another fingerprint and the expected another finger print may be enlarged or decreased by comprising more or less sub-fingerprints 210.

In another embodiment of the method each fingerprint 285 may comprise more than 1 sub-fingerprints 210, each sub-fingerprint 210 comprising L bits, L being an integer larger than 1. The number of bits comprised in each fingerprint 285 (chosen from the group comprising the calculated fingerprint 30, the expected fingerprint 130, the another fingerprint 110 and the expected another fingerprint 120) may be enlarged or decreased by comprising more or less bits in one or more sub-fingerprints 210 that are comprised in said fingerprint 285.

Returning to FIG. 1, the number of bits comprised in the calculated fingerprint 30 may be related to the expected fingerprint 130 or the another expected fingerprint 120 comprised in the fingerprint database 60.

In an embodiment by consulting said database 60 a number of bits of the expected fingerprint 130 or the another expected fingerprint 120 may be determined Said determined number of bits may be used to determine the number of bits for the calculated fingerprint 30.

Instead of counting the bits of the expected fingerprint 130 or the another expected fingerprint 120 the number of bits comprised in the calculated fingerprint may be determined in other ways.

In a further embodiment of the method the number of bits comprised in the calculated fingerprint 30 may be determined in dependence of the number of sub-fingerprints comprised in the calculated fingerprint 30 having no matched sub-fingerprint in the expected fingerprint 130. Or likewise the number of bits may be determined in dependence of the number of sub-fingerprints comprised in the another calculated fingerprint 110 having no matched sub-fingerprint in the another expected fingerprint 120.

In a further embodiment of the method the number of bits comprised in the calculated fingerprint is determined in dependence of a bit error ratio resulting from a comparison of the calculated fingerprint 30 with the expected fingerprint 130 or from a comparison of the another calculated fingerprint 110 with the another expected fingerprint 120.

In the embodiments discussed above the another calculated fingerprint 110 and its corresponding another expected fingerprint 120 relate to another portion 100 of the content stream 10. Said another portion 100 may be preceding the portion 20 of the content stream from which the calculated fingerprint 30 and its corresponding expected fingerprint 130 may be determined. With said another calculated fingerprint 110 and its corresponding expected fingerprint 120 it may be established how difficult or easy the synchronization is.

The another portion 100 may further overlap the portion 20 or precede and overlap the portion 20.

Returning to FIG. 2 in another embodiment a sub-fingerprint 210 may be determined using the luminance differences between two blocks 235 of video material within one frame 220. Each frame 220 is divided in a plurality of blocks 235. A matrix 230 having N rows and M columns and N×M elements, each element representing a block 235, may represent the frame 220, N and M being integers larger than 1. Each block 235 may comprise a plurality of pixels, and an average luminance of the pixels comprised in said block 235 may be determined. Said average luminance may have a value ranging from 0, corresponding to black, to 255, corresponding to white. An element in a row may have one or two neighboring elements in said row, dependent on where in the matrix 230 the element is located. An element having two neighboring elements may form a pair with each one of said neighboring elements. The matrix 230 may comprise (N×(M−1)) pairs of elements and for each pair a first difference 240 of their associated luminance is determined, resulting in a first array 250 comprising L first elements, L being equal to (N×(M−1)). The value of each one of said L first elements may be represented by a predetermined number of bits.

Not shown in FIG. 2 is that depending on whether the difference in luminance is positive or negative a first element in the first array may be set to 1 or 0. In a further embodiment the first array 250 comprise L bits and may be used as a sub-fingerprint.

Returning to FIG. 2 and the another embodiment for two frames 220 in each portion of the content stream their corresponding first array 250 is determined. A second difference 260 of the corresponding first elements of these first arrays 250 is determined providing L second elements, comprised in a second array 270. Each one of these second elements may have a value for ‘a difference of the average luminance difference’ ranging from −510 to +510. The value smaller than zero provides a corresponding sub-fingerprint bit 200 comprised in the sub-fingerprint 210 equal to 0, and the value larger than zero results in the corresponding sub-fingerprint bit to be equal to 1. Thus L sub-fingerprint bits 200 are obtained each having a bit value in dependence of a polarity sign of the value of ‘the difference of the average luminance difference’.

In a further embodiment said two frames 220 are consecutive frames. In yet a further embodiment the elements in said pair of elements have a succeeding row number or a succeeding column number.

In dark scenes the average luminance of a block 235 may be low, and the corresponding value of the first element may be close to zero. When there are dark scenes in the content stream there may be a plurality of consecutive frames 220 comprised in those dark scenes having similar first arrays 250. Consequently sub-fingerprints obtained, calculated or determined from these first arrays 250, or differences from the first elements comprised in these first arrays may not provide a reliable synchronization of the content portion 20 and the corresponding script portion. Thus depending on a number of first elements having a value close to zero, or on the number of corresponding first elements of consecutive frames having a value close to zero it may be determined to change the size of the blocks 235 in the frame 220. If the average luminance is calculated using fewer pixels a contribution of a group of pixels with higher than average luminance will increase. Thus lighter spots or objects in the other wise dark scene will get a larger contribution in the value of the first elements. Thus the number of bits in the sub-fingerprint may be changed in dependence of the number of first elements having a value close to zero, or in dependence of the number of corresponding first elements of consecutive frames having a value close to zero. In a further embodiment of the method at least one of N and M is adapted in dependence of the value of at least one of the first elements comprised in the first array 250.

In a further embodiment of the method for each one of the sub-fingerprints 210 a quality number is determined. Said quality number is dependent on the sum of the absolute values of the L second elements comprised in the second array 270. Said quality number gives a measure for a difference of spatial and temporal block luminance. A larger difference means that it is easier to discriminate between frames, providing a sub-fingerprint that may be more unique. Consequently the synchronization of the content stream and the script is more reliable using the sub-fingerprints having a larger quality number.

By adding the quality numbers of the sub-fingerprints 210 comprised in a fingerprint 285 a quality number of said fingerprint is obtained. Said quality number may be added in the timetable or fingerprint database. Thus said database may comprise for each expected fingerprint also the quality number corresponding to said expected fingerprint. In a further embodiment of the method the number of bits comprised in the calculated fingerprint is dependent on at least the quality numbers of the sub-fingerprints 210 comprised in the expected fingerprint 130 or the another expected fingerprint.

Also for the calculated fingerprint and the another calculated fingerprint the quality number may be determined. The number of bits to be comprised in said calculated fingerprint may be dependent on said quality number. Therefore in a further embodiment of the method the number of bits may be dependent on at least the quality numbers of the sub-fingerprints 210 comprised in the calculated fingerprint 30. The number of bits may be further dependent on the quality number of the another calculated fingerprint and it may be determined to increase or decrease the number of bits comprised in the calculated fingerprint by changing the number of sub-fingerprints comprised in the calculated fingerprint or by changing the number of bits comprised in a sub-fingerprint.

After ‘a jump’ in the content stream such as caused by ‘fast forward’ or ‘next track’ the script needs to be synchronized with the content stream again. The fingerprint Fx calculated from the portion of the content stream just after the jump needs to be matched with a corresponding expected fingerprint FTX in the database to determine the time Tx corresponding to said portion of the content stream. The number of bits to be comprised in the calculated fingerprint for said portion may be different from another number of bits that would be obtained when there would have been no jump and the content stream synchronized with the script would have been played out. In a further embodiment of the method the timetable or database 60 may comprise at least two expected fingerprints corresponding to said time Tx, the at least two expected fingerprints comprising a different number of bits. The calculated fingerprint calculated from the portion of the content stream just after the jump may be matched with one of the at least two expected fingerprints, thereby increasing the reliability of the method for synchronizing the content stream and the script under the condition of a jump in the content stream. Said different number of bits may be obtained by comprising different number of bits in the sub-fingerprints of the at least two expected fingerprints, or by comprising a different number of sub-fingerprints in the two expected fingerprints.

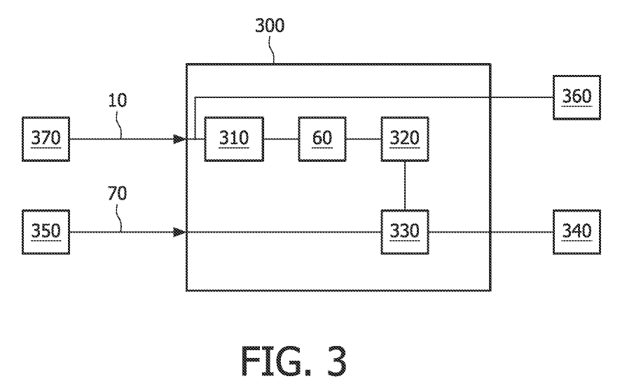

Referring to FIGS. 1 and 3, the content stream 10 is received by the receiver 300. Each portion 100, 20 of the content stream is sampled by the fingerprint calculator 310 and a corresponding fingerprint is determined (e.g., FT0, FT1, FT2, FT3, FTN) that is output to the fingerprint database 60. Each fingerprint is used as a key that is searched for in the fingerprint database 60 to determine the corresponding time value (e.g T0, T1, T2, . . . TN). The result of the search is the corresponding time value that may then be utilized to adjust a clock 320. The adjusted clock 320 is thereafter utilized to synchronize a script output generator 330 with the rendering of the content stream 10. In this way, as for example, a content portion 20 with determined fingerprint FT2 is accessed for rendering, whether it is by serial access or random access by the user (e.g., fast forward, rewind, etc.), the script 90 that is to be initiated at this time (e.g., a portion of the script shown corresponding to start time T2) is accessed by the script output generator 330 and may be provided to an effects controller 340 for rendering effects that are synchronized to the rendering of the content portion 20. In an embodiment a script server 350 may provide the script. The content stream is further provided to a playback device 360.

The content stream 10 may be distributed by a distribution/transmission channel including a broadcast channel, the Internet, via optical media, such as digital versatile disks (DVDs) 370, etc. The script 70, and the fingerprint and time value pairs 130, 40 may be provided by the script server 350 that, in one embodiment, distributes the script and the fingerprint and time value pairs over the same distribution system as the content stream, such as over the Internet. The script 70 and the plurality of fingerprint and time value pairs 130, 40 may be distributed together with the content stream 10, or may be distributed separate from the content stream and be provided by another source that, for example, provides designed scripts for the content. In an embodiment the script server 350 may be a DVD that contains the script and the plurality of fingerprint and time value pairs. A local DVD player may access said DVD.

In accordance with the present receiver 300, regardless of how the content stream 10, the script 70 and the plurality of fingerprint and time value pairs are received 130, 40, the receiver provides a synchronization of the content stream 10 and the script 70. The receiver 300 for synchronizing the received content stream 10 and the script 70 comprises

means 310 for calculating a fingerprint 30 comprising P bits from a portion 20 of the content stream 10, P being an integer larger than 1;

means 320 for determining a time value 40 corresponding to the fingerprint 30;

means 330 for synchronizing the script portion 90 that corresponds to the time value 40 and the portion 20 of the content stream.

The script 70 represents one or more sensory effects to be output in an effects signal to an effects controller 340. To improve the reliability of the synchronization the present receiver 300 is characterized in further comprising means arranged to adapt the value of P in dependence of at least one of the fingerprints chosen from a group comprising the calculated fingerprint 30, an expected fingerprint 130 corresponding to said calculated fingerprint, another calculated fingerprint 110 calculated from another portion 100 of said content stream, and another expected fingerprint 120 corresponding to said another calculated fingerprint 110.

As discussed previously by making the number of P bits of the calculated fingerprint 30 variable instead of fixed it becomes possible to adapt the calculated fingerprint 30 to an actual content position of the content stream 10. A unique calculated fingerprint of content with a plurality of dark or static scenes may require an increased number of bits to enable reliable synchronization. The number of P bits of the calculated fingerprint is adapted in dependence of the calculated fingerprint 30 itself or on another fingerprint 110 calculated from another portion 100 of the content stream 10. The number of P bits may also be adapted in dependence of the expected fingerprint 130 corresponding to the calculated fingerprint 30 or the another expected fingerprint 120 corresponding to the another calculated fingerprint 110. Thus with the present receiver 300 the calculated fingerprint 30 may have an increased uniqueness providing an increased reliability of the synchronization of the content stream 10 with the script 70.

In an embodiment of the receiver 300 the means to adapt the value of P are arranged to determine the number of sub-fingerprints comprised in the calculated fingerprint 30 having no matched sub-fingerprint in the expected fingerprint 130. In a further embodiment of the receiver 300 the means to adapt the value of P are arranged to determine the number of sub-fingerprints comprised in the another calculated fingerprint 110 having no matched sub-fingerprint in the another expected fingerprint 120.

In a further embodiment of the receiver 300 the means to adapt the value of P are arranged to determine a bit error ratio resulting from a comparison of the calculated fingerprint 30 with the expected fingerprint 130.

In a further embodiment of the receiver 300 the means to adapt the value of P are arranged to determine a bit error ratio resulting from a comparison of the another calculated fingerprint 110 with the another expected fingerprint 120.

In a further embodiment of the receiver 300 the means to adapt the value of P are arranged to determine the number of bits of the another expected fingerprint 120 or the expected fingerprint 130.

In a further embodiment of the receiver 300 the means to adapt the value of P are in dependence of at least the quality numbers of the sub-fingerprints 210 comprised in the expected fingerprint 130. Said quality numbers may be dependent on the sum of the absolute values of the L second elements comprised in the second array 270, as previously discussed.

The effects that are controlled by the script 70 may be related to sound, temperature, wind, vibrations, smells, etc., and are only limited by the imagination of a script designer and effects equipment available to a user. In accordance with the present receiver 300, the appropriate effects, under control of the script 70, are rendered in synchronization with the content stream 10 by the effects controller 340. The effects controller 340 may provide control signals for appropriate effect generating devices, and are not further shown.

In a further embodiment of the receiver 300 according to any one of claims 19-25 the means for synchronizing the script 70 is configured to provide an output to control one or more sensory effects selected from the group of lights, sounds, vibrations, winds and smells.

1. A method for synchronizing a content stream and a script for outputting one or more sensory effects in a multimedia system, the method comprising:
a) calculating a fingerprint comprising a number of bits from a portion of the content stream;
b) determining a time value corresponding to the calculated fingerprint (30), by comparing said calculated fingerprint with a plurality of expected fingerprints associated with the content stream;
c) synchronizing a portion of the script that corresponds to the time value and the portion of the content stream, the script representing one or more sensory effects to be output in an effects signal to an effects controller, and
d) the number of bits being determined in dependence of at least one of the fingerprints selected from a group comprising the calculated fingerprint, an expected fingerprint corresponding to said calculated fingerprint, another calculated fingerprint calculated from another portion of said content stream, and another expected fingerprint corresponding to said another calculated fingerprint.

2. A method according to claim 1 wherein at least one of the calculated fingerprint, the another calculated fingerprint and the plurality of expected fingerprints comprise a plurality of sub-fingerprints, each sub-fingerprint being calculated from a predetermined number of frames in the content stream, the calculated fingerprint comprising K sub-fingerprints, K being an integer larger than 1.

3. A method according to claim 1 wherein at least one of the calculated fingerprint, the another calculated fingerprint and the plurality of expected fingerprints comprise a plurality of sub-fingerprints, each sub-fingerprint being calculated from a predetermined number of frames comprised in the content stream, the sub-fingerprints comprised in the calculated fingerprint comprising L bits, L being an integer larger than 1.

4. A method according to claim 1 wherein the another portion is one of preceding and preceding and overlapping the portion.

5. A method according to claim 1 wherein d) comprises:
d1) determining a number of sub-fingerprints comprised in the calculated fingerprint having no matched sub-fingerprint in the expected fingerprint.

6. A method according to claim 1 wherein d) comprises:
d1) determining a number of sub-fingerprints comprised in the another calculated fingerprint having no matched sub-fingerprint in the another expected fingerprint.

7. A method according to claim 1 wherein d) comprises:
d1) determining a bit error ratio resulting from a comparison of the calculated fingerprint with the expected fingerprint.

8. A method according to claim 1 wherein d) comprises:
d1) determining a bit error ratio resulting from a comparison of the another calculated fingerprint with the another expected fingerprint.

9. A method according to claim 1 wherein d) comprises:
d1) determining a number of bits of the another expected fingerprint or the expected fingerprint.

10. A method according to claim 1 wherein each fingerprint comprises K sub-fingerprints, and each sub-fingerprint comprises L bits, and each one of the frames comprises a matrix having N rows and M columns, the matrix comprising (N×(M−I)) pairs of elements, each element having an associated average luminance, K, L, N, M being integers larger than one, and wherein for each pair of elements in each matrix a first difference of the associated luminance of the elements of said pair is determined, resulting in a first array comprising L first elements, L being equal to N×(M−I), and wherein further for two consecutive frames a second difference of corresponding first elements of the first arrays corresponding to said two consecutive frames is determined resulting in a second array comprising L second elements, each one of the L bits comprised in each fingerprint being dependent on a polarity sign of a corresponding one of the L second elements in the second array.

11. A method according to claim 10 wherein at least one of N and M is adapted in dependence of the value of at least one of the first elements in the first array.

12. A method according to claim 10 wherein the elements in said pair of elements have a succeeding row number or a succeeding column number.

13. A method according to claim 10 wherein for each one of the sub-fingerprints a quality number is determined, said quality number being dependent on the sum of the absolute values of the L second elements in the second array.

14. A method according to claim 13 wherein d) comprises:
d1) determining at least the quality numbers of the sub-fingerprints in the expected fingerprint.

15. A method according to claim 13 wherein d) comprises:
d1) determining at least the quality numbers of the sub-fingerprints in the another calculated fingerprint.

16. A method according to claim 13 wherein d) comprises:
d1) determining at least the quality numbers of the sub-fingerprints comprised in the calculated fingerprint.

17. A method according to claim 14 wherein d) further comprises:
d1) determining the number of bits L of the sub-fingerprints in the calculated fingerprint.

18. A method according to claim 17 wherein a timetable comprises for the calculated fingerprint at least two corresponding expected fingerprints, said two corresponding expected fingerprints comprising a different number of bits.

19. A receiver for synchronizing a received content stream and a script for outputting one or more sensory effects in a multimedia system, the receiver comprising:
means for calculating a fingerprint comprising P bits from a portion of the content stream, P being an integer larger than 1;
means for determining a time value corresponding to the fingerprint;
means for synchronizing a portion of the script that corresponds to the time value and the portion of the content stream;
the script representing one or more sensory effects to be output in an effects signal to an effects controller, and
means arranged to adapt the value of P in dependence of at least one of the fingerprints selected from a group comprising the calculated fingerprint, an expected fingerprint corresponding to said calculated fingerprint, another calculated fingerprint calculated from another portion of said content stream, and another expected fingerprint corresponding to said another calculated fingerprint.

20. A receiver according to claim 19 wherein the means to adapt the value of P are arranged to determine a number of sub-fingerprints in the calculated fingerprint having no matched sub-fingerprint in the expected fingerprint.

21. A receiver according to claim 19 wherein the means to adapt the value of P are arranged to determine a number of sub-fingerprints in the another calculated fingerprint having no matched sub-fingerprint in the another expected fingerprint.

22. A receiver according to claim 19 wherein the means to adapt the value of P are arranged to determine a bit error ratio resulting from a comparison of the calculated fingerprint with the expected fingerprint.

23. A receiver according to claim 19 wherein the means to adapt the value of P are arranged to determine a bit error ratio resulting from a comparison of the another calculated fingerprint with the another expected fingerprint.

24. A receiver according to claim 19 wherein the means to adapt the value of P are arranged to determine a number of bits of the another expected fingerprint or the expected fingerprint.

25. A receiver according to claim 19 wherein the means to adapt the value of P are arranged to adapt the value of P in dependence of at least the quality numbers of the sub-fingerprints in the expected fingerprint, the quality numbers being determined in accordance with claim 13.

26. A receiver according to claim 19 wherein the means for synchronizing the script is configured to provide an output to control one or more sensory effects selected from the group comprising lights, sounds, vibrations, winds and smells.
